(19) United States
(12) Patent Application Publication
(10) Pub. No.: US 2022/0097165 A1
(43) Pub. Date: Mar. 31, 2022

(54) CONDUCTIVE SHEET AS CURRENT CONDUCTOR TO SPOT WELD STEEL

(71) Applicant: GM Global Technology Operations LLC, Detroit, MI (US)

(72) Inventors: Amberlee S. Haselhuhn, Troy, MI (US); Adam R. Ballard, Chesterfield, MI (US); David R. Sigler, Shelby Township, MI (US); Peter M. Parlow, Columbus, MI (US); Mark A. Nelson, Rochester, MI (US)

(21) Appl. No.: 17/038,368

(22) Filed: Sep. 30, 2020

(51) Int. Cl. B23K 11/20; B23K 11/11

(52) U.S. Cl. CPC B23K 11/20; B23K 2101/006; B23K 11/115

(57) ABSTRACT

A method to join three panels together for a motor vehicle includes one or more of the following: layering the three panels, the three panels including a first panel, a second panel, and a third panel, the second panel being positioned between the first panel and the third panel, the third panel having a higher electrical conductivity than the first panel and the second panel; joining the first panel and the second panel together; and joining the third panel to the first panel and the second panel.

### INTRODUCTION

The present disclosure relates to joining panels together for motor vehicles. More particularly, the present disclosure relates to joining steel panels and another conductive panel together for motor vehicles.

During the manufacturing of motor vehicles, various panels made of different materials are joined together. For example, during the construction process of a motor vehicle, the body of the motor vehicle is made of steel and other panels. More specifically, some panels of steel are joined with other panels that are made of, for example, aluminum. Typically, the construction process requires multiple steps to produce a component for the motor vehicle.

Thus, while current systems to join layered panels for motor vehicles achieve their intended purpose, there is a need for a new and improved system and method for joining layered panels.

### SUMMARY

According to several aspects, a method to join three panels together for a motor vehicle includes one or more of the following: layering the three panels, the three panels including a first panel, a second panel, and a third panel, the second panel being positioned between the first panel and the third panel, the third panel having a higher electrical conductivity than the first panel and the second panel; joining the first panel and the second panel together; and joining the third panel to the first panel and the second panel.

In an additional aspect of the present disclosure, joining the first panel and the second panel together occurs before joining the third panel to the first panel and the second panel.

In another aspect of the present disclosure, joining the third panel to the first panel and the second panel occurs before joining the first panel and the second panel together.

In another aspect of the present disclosure, joining the third panel to the first panel and the second panel occurs at the same time as joining the first panel and the second panel together.

In another aspect of the present disclosure, the first panel is made of steel and the second panel is made of steel.

In another aspect of the present disclosure, joining the first panel and the second panel together includes spot welding.

In another aspect of the present disclosure, the third panel is made of aluminum.

In another aspect of the present disclosure, the third panel is made of magnesium.

In another aspect of the present disclosure, joining the third panel to the first panel and the second panel includes riveting the third panel to the first panel and the second panel.

In another aspect of the present disclosure, joining the third panel to the first panel and the second panel includes friction welding, resistance welding, or applying an adhesive.

In another aspect of the present disclosure, the first and second panels have a resistivity above 100 nano-ohm·m, and the third panel has a resistivity below 100 nano-ohm·m.

In another aspect of the present disclosure, the first and second panels have a resistivity above 140 nano-ohm·m and the third panel has a resistivity below 65 nano-ohm·m.

According to several aspects, a method to join three panels together for a motor vehicle includes one or more of the following: layering the three panels, the three panels including a first electrically conductive panel, a second electrically conductive second panel, and a third electrically conductive panel, the second electrically conductive panel being positioned between the first electrically conductive panel and the third electrically conductive panel, the third electrically conductive panel having a higher electrically conductivity than the first electrically conductive panel and the second electrically conductive panel; joining the first electrically conductive panel and the second electrically conductive panel together; and joining the third electrically conductive panel to the first electrically conductive panel and the second electrically conductive panel.

In another aspect of the present disclosure, joining the first electrically conductive panel and the second electrically conductive panel together occurs before joining the third electrically conductive panel to the first electrically conductive panel and the second electrically conductive panel.

In another aspect of the present disclosure, joining the third electrically conductive panel to the first electrically conductive panel and the second electrically conductive panel occurs before joining the first electrically conductive panel and the second electrically conductive panel together.

In another aspect of the present disclosure, joining the third electrically conductive panel to the first electrically conductive panel and the second electrically conductive panel occurs at the same time as joining the first electrically conductive panel and the second electrically conductive panel together

In another aspect of the present disclosure, the first electrically conductive panel is made of steel and the second electrically conductive panel is made of steel.

In another aspect of the present disclosure, joining the first electrically conductive panel and the second electrically conductive panel together includes spot welding.

In another aspect of the present disclosure, the third electrically conductive panel is made of aluminum.

In another aspect of the present disclosure, the third electrically conductive panel is made of magnesium.

In another aspect of the present disclosure, joining the third electrically conductive panel to the first electrically conductive panel and the second electrically conductive panel includes riveting, friction welding, resistance welding, or applying an adhesive.

In another aspect of the present disclosure, the first and second panels have a resistivity above 100 nano-ohm·m, and the third panel has a resistivity below 100 nano-ohm·m.

In another aspect of the present disclosure, the first and second panels have a resistivity above 140 nano-ohm·m and the third panel has a resistivity below 65 nano-ohm·m.

According to several aspects, a structure of three panels joined together for a motor vehicle includes a first panel of steel, a second panel of steel, a panel of aluminum, the second panel of steel being positioned between the first panel of steel and the panel of aluminum. The first panel of steel, the second panel of steel and the panel of aluminum are layered together before the panels are joined together. The first panel of steel and the second panel of steel are joined together by spot welding with a weld imprint appearing on only the first panel of steel, the panel of aluminum having an imprint with no melting.

In another aspect of the present disclosure, the panel of aluminum is joined to the first panel of steel and the second panel of steel by riveting, friction welding, resistance welding, or applying an adhesive.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 shows a system to join three panels together in accordance with an exemplary embodiment;

FIG. 2 shows an example of three panels utilizing the system shown in FIG. 1 in accordance with an exemplary embodiment; and

FIG. 3 shows a process to join three panels together in accordance with an exemplary embodiment.

### DETAILED DESCRIPTION

The following description is merely exemplary in nature and is not intended to limit the present disclosure, application, or uses.

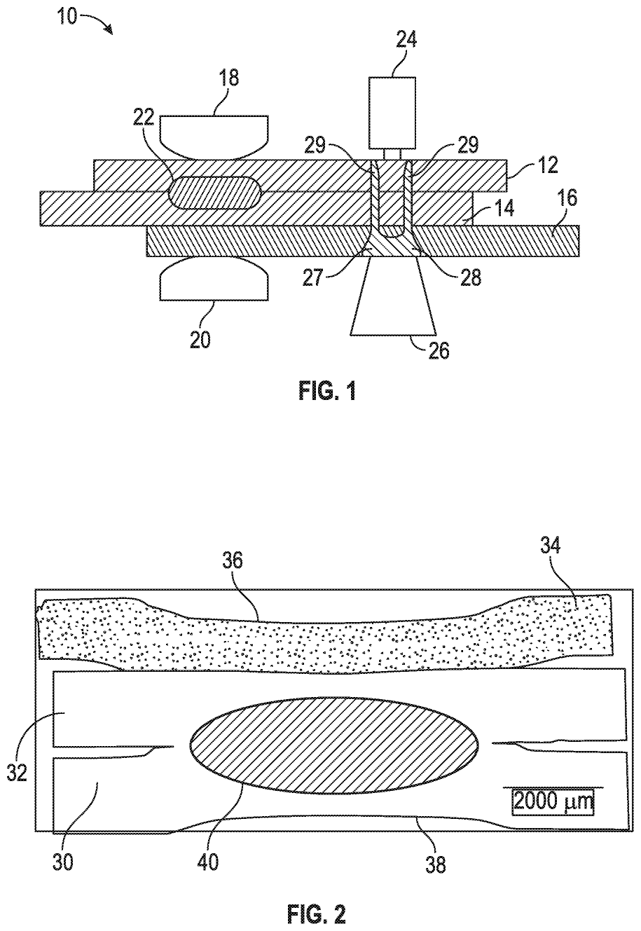

Referring to FIG. 1, there is shown a system 10 to join, for example, a first steel panel 12, a second steel panel 14 and a third electrically conductive panel 16 together. In some arrangements, the panel 16 is made of aluminum, while in other arrangements the panel 16 is made of magnesium or any other suitable electrically conductive material. In certain arrangements, the panels 12 and 14 have a resistivity above 100 nano-ohm·m, while the panel 16 has a resistivity below 100 nano-ohm·m. In particular arrangements, the panel 16 have a resistivity below 65 nano-ohm·m, while the panels have a resistivity above 140 nano-ohm·m.

Prior to joining the three panels together, the three panels 12, 14 and 16 are layered as shown in FIG. 1. In some arrangements, resistance spot weld electrodes 18 and 20 are utilized to create a spot weld 22 to join the first steel panel 12 and the second steel panel 14. More specifically, the panels 12, 14 and 16 are positioned between the electrodes 18 and 20, which are energized to create the spot weld 22 to join the steel panels 12 and 14 together. The panel 16 is joined to the panels 12 and 14 by a rivet 27. Specifically, a rivet gun 26 drives the rivet 27 towards a rivet guide 24. As such, the rivet 27 with a head portion 28 and projections 29 connect the three panels 12, 14 and 16 together. Note that the creation of the spot weld 22 occurs before the placement of the rivet 27 in some arrangements, while in other arrangements, the three panels 12, 14 and 16 are joined together with the rivet 27 before the steel panels 12 and 14 are joined together with the spot weld 22. In various arrangements the creation of the spot weld 22 and the placement of the rivet 26 occur simultaneously. In certain arrangements, friction welding is utilized to join the panel 16 to the panels 12 and 14, while in other arrangements resistance welding is utilized to join the panel 16 to the panels 12 and 14. Again, regardless of how the panel 16 is joined to the panels 12 and 14, the spot welding of the panels 12 and 14 together occurs before the panel 16 is joined to the panels 12 and 14 in some arrangements, while in other arrangements, the panel 16 is joined to the panels 12 and 14 before the panels 12 and 14 are joined together by the spot welding process.

Referring now to FIG. 2, there is shown an example of two panels of steel 30 and 32 and a panel of aluminum 34 layered together. A spot welding process is utilized to join the panels 30 and 32 by placing the panels 30, 32 and 34 between a set of electrodes and then energizing the electrodes forming a spot weld nugget 40. As evident in FIG. 2, there is a minimal imprint 38 in the steel panel 30 and a minimal imprint 36 in the aluminum pane 34 created by the spot welding process. Note that the aluminum panel 34 is not melted, but only slightly deformed, whereas fusion occurs between the steel panels 30 and 32. There is, however, no imprint on the steel panel 32 occurs, although some thinning or deformation of the steel panel 32 may occur.

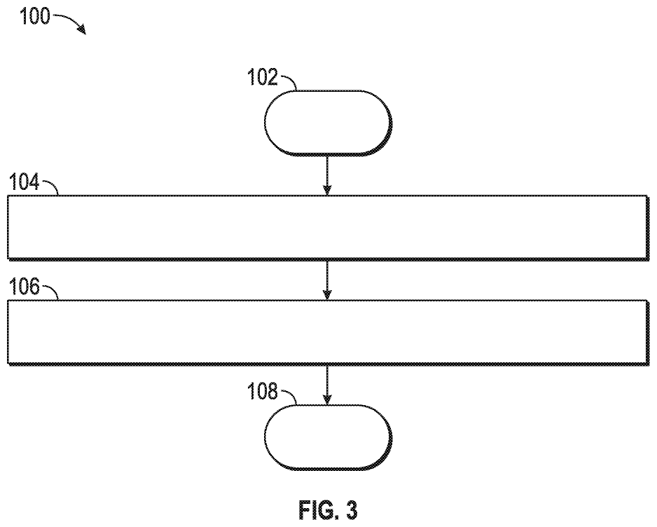

Referring now to FIG. 3, there is shown a process 100 to join the steel panels 12 and 14 and the electrically conductive panel 16 together. The process 100 initializes in step 102 and the three panels 12, 14 and 16 are layered in step 104 with the steel panel 14 being positioned between the steel panel 12 and the aluminum panel 16.

In step 106, the steel panels 12 and 14 are joined together by a spot welding process and the aluminum panel 16 is joined to the steel panels 12 and 14 by a riveting process. In other arrangements, in step 106, the aluminum panel 16 is joined to the steel panels 12 and 14 by the riveting process and the steel panels 12 and 14 are subsequently or simultaneously joined together by a spot welding process. In various arrangements, rather than utilizing a riveting process, a friction welding process is utilized to joined the aluminum panel 16 to the steel panels 12 and 14, while in other arrangements, resistance welding is utilized to join the aluminum panel 16 to the steel panels 12 and 14. The process 100 ends in step 108.

In sum, the present disclosure describes a method and system to simultaneously spot weld two or more steel panels while utilizing a separate joining process (rivet, resistance weld, friction weld) to join a third panel with disparate material properties to the panels of steel. More specifically, the disclosure describes utilizing a third conductive panel as a current conductor to form a weld nugget in the steel panels without damaging the third panel. Moreover, the disclosure describes a process in which a weld imprint occurs in only one steel panel.

A system 10 and a process 100 of the present disclosure offers several advantages. These include enabling the use of non-structural and semi-structural joints to join a panel to steel structures in a motor vehicle. The process enables the reduction of rivets required to join, for example, aluminum, to steel structures and also enables the utilization of various joining processes to join aluminum to steel panels. Further, the system 10 and the process 100 enables the utilization of additional welds that can be implemented later in the manufacturing process.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method to join three panels together for a motor vehicle, the method comprising:
layering the three panels, the three panels including a first panel, a second panel, and a third panel, the second panel being positioned between the first panel and the third panel, the third panel having a higher electrical conductivity than the first panel and the second panel;
joining the first panel and the second panel together; and
joining the third panel to the first panel and the second panel.

2. The method of claim 1, wherein joining the first panel and the second panel together occurs before joining the third panel to the first panel and the second panel.

3. The method of claim 1, wherein joining the third panel to the first panel and the second panel occurs before joining the first panel and the second panel together.

4. The method of claim 1, wherein joining the third panel to the first panel and the second panel occurs at the same time as joining the first panel and the second panel together.

5. The method of claim 1, wherein the first panel is made of steel and the second panel is made of steel.

6. The method of claim 5, wherein joining the first panel and the second panel together includes spot welding.

7. The method of claim 1, wherein the third panel is made of aluminum.

8. The method of claim 1, wherein the third panel is made of magnesium.

9. The method of claim 1, wherein joining the third panel to the first panel and the second panel includes riveting the third panel to the first panel and the second panel.

10. The method of claim 1, wherein joining the third panel to the first panel and the second panel includes friction welding, resistance welding, or applying an adhesive.

11. The method of claim 1, wherein the first and second panels have a resistivity above 100 nano-ohm·m, and the third panel has a resistivity below 100 nano-ohm·m.

12. The method of claim 11, wherein the first and second panels have a resistivity above 140 nano-ohm·m and the third panel has a resistivity below 65 nano-ohm·m.

13. A method to join three panels together for a motor vehicle, the method comprising:
layering the three panels, the three panels including a first electrically conductive panel, a second electrically conductive second panel, and a third electrically conductive panel, the second electrically conductive panel being positioned between the first electrically conductive panel and the third electrically conductive panel, the third electrically conductive panel having a higher electrically conductivity than the first electrically conductive panel and the second electrically conductive panel;
joining the first electrically conductive panel and the second electrically conductive panel together; and
joining the third electrically conductive panel to the first electrically conductive panel and the second electrically conductive panel.

14. The method of claim 13, wherein joining the first electrically conductive panel and the second electrically conductive panel together occurs before joining the third electrically conductive panel to the first electrically conductive panel and the second electrically conductive panel.

15. The method of claim 13, wherein joining the third electrically conductive panel to the first electrically conductive panel and the second electrically conductive panel occurs before joining the first electrically conductive panel and the second electrically conductive panel together.

16. The method of claim 13, wherein joining the third electrically conductive panel to the first electrically conductive panel and the second electrically conductive panel occurs at the same time as joining the first electrically conductive panel and the second electrically conductive panel together.

17. The method of claim 13, wherein the first electrically conductive panel is made of steel and the second electrically conductive panel is made of steel.

18. The method of claim 17, wherein joining the first electrically conductive panel and the second electrically conductive panel together includes resistance spot welding.

19. The method of claim 13, wherein the third electrically conductive panel is made of aluminum.

20. The method of claim 13, wherein the third electrically conductive panel is made of magnesium.

21. The method of claim 13, wherein joining the third electrically conductive panel to the first electrically conductive panel and the second electrically conductive panel includes riveting, friction welding, resistance welding, or applying an adhesive.

22. The method of claim 13, wherein the first and second panels have a resistivity above 100 nano-ohm·m, and the third panel has a resistivity below 100 nano-ohm·m.

23. The method of claim 22, wherein the first and second panels have a resistivity above 140 nano-ohm·m and the third panel has a resistivity below 65 nano-ohm·m.

24. A structure of three panels joined together for a motor vehicle, the structure comprising:
a first panel of steel;
a second panel of steel; and
a panel of aluminum, the second panel of steel being positioned between the first panel of steel and the panel of aluminum,
wherein the first panel of steel, the second panel of steel and the panel of aluminum are layered together before the panels are joined together, and
wherein the first panel of steel and the second panel of steel are joined together by spot welding with a weld imprint appearing on only the first panel of steel, the panel of aluminum having an imprint with no melting.

25. The system of claim 24, wherein the panel of aluminum is joined to the first panel of steel and the second panel of steel by riveting, friction welding, resistance welding, or applying an adhesive.
